(19) United States
(12) Patent Application Publication
(10) Pub. No.: US 2009/0280425 A1
(43) Pub. Date: Nov. 12, 2009

(54) Black Toner Formulations

(76) Inventors: Gary Allen Denton, Lexington, KY (US); John Joseph Kraseski, Lexington, KY (US); Jing X. Sun, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/118,239

(22) Filed: May 9, 2008

(51) Int. Cl. G03G 9/087

(52) U.S. Cl. 430/108.8; 430/105; 430/109.4; 430/109.2

(57) ABSTRACT

Black toner formulations for electrophotography. The black toner formulations include an optimum concentration of one or more black colorants. Further, the black toner formulation includes either a polymeric dispersant, a binder, a wax, or combinations thereof. The one or more black colorants exhibit a low absorption in near infrared spectrum ranging from a wavelength of about 700 nanometers (nm) to a wavelength of about 1100 nm. Moreover, the black toner formulations exhibit a bulk toner powder reflectivity of greater than about 8 percent and less than about 60 percent, at a wavelength of about 940 nm, for toner particles having sizes ranging from about 5.5 to about 10 microns.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC

None.

### BACKGROUND

1. Field of the Disclosure

The present disclosure relates to a black toner formulation for use in electrophotography for generating dark electrophotographic images, and more specifically, to a black toner formulation that is characteristic of exhibiting a low absorbance in near infrared spectrum.

2. Description of the Related Art

Electrophotography is a widely used printing technique that includes generation of an image on an image-receiving medium using a toner. Suitable examples of the image-receiving medium include, but are not limited to, paper, plastic, and textile. The technique of electrophotography is broadly used in photocopying machines, laser printers, Light-Emitting Diode (LED) printers, and the like. More specifically, the technique includes a transfer of a specific toner to an image-receiving medium with the help of electrostatic charges. In other words, any printing system working on the principles of electrophotography employs an image-receiving medium that during the course of a printing process gets entrenched with variable areas of the electrostatic charges that correspond to an image to be printed. These variable areas of electrostatic charges interact with the specific toner that subsequently may be fused and fixed on the image-receiving medium to generate thereon a printed image.

In general, a desirable quantity of a toner is required for printing images of a good quality on an image-receiving medium. Such a desirable quantity may be defined in terms of density, mass per unit area (M/A) of the toner, which is ideally characterized by a number of monolayers of the toner to collectively form a toner layer as applied on the image-receiving medium to form an image thereon. More specifically, an ideal value of the M/A ranges from about 1.5 to about 3 monolayers of the toner. Therefore, controlling the quantity of the toner, and thereby ensuring consistent color reproducibility each time while printing requires a control over thickness of each toner monolayer as applied over the image-receiving medium. Such a regulation aids in stabilizing print density of solid areas, and to a lesser extent, in stabilizing print density of halftone shades. Consequently, toner patch sensors have been employed in electrophotography-based printing systems to control thickness of the toner layer applied over the image-receiving medium. The toner patch sensors are capable of monitoring the toner density of unfused images, thereby providing a means to control darkness of the printed images.

Control of image darkness that is retrospective of color of a toner and intensity thereof, has always been challenging in electrophotography-based printing systems. More specifically, such a problem is prevalent for producing dark images using a black toner. Most often than not, the problem is due in part to the inherent variability of the electrophotographic technique.

In general, a conventional black toner used for generating black colored fixed or stable images employs a black colorant. Suitable examples of the black colorant may include, but are not limited to, carbon black, inorganic black pigments, infrared reflective black pigments, organic black pigments, infrared transmissive black colorants, and combinations thereof. It should be understood that a specific black colorant may be formulated to produce various particles thereof that may be used to prepare the black toner.

A conventional black toner that has a carbon black loading of equal to or greater than about 5 percent by weight strongly absorbs light in a wavelength of about 300 nanometers (nm) to about 2000 nm. Therefore, the conventional black toner may produce a relatively weak reflected infrared signal for a toner patch sensor that operates at a wavelength near 940 nm, hereinafter referred to as the ‘toner patch sensor wavelength’. More specifically, as the toner patch sensor emits and detects light at a wavelength ranging from about 750 nm to about 1000 nm, and more particularly, from about 900 nm to about 1000 nm, strong absorbance at the toner patch sensor wavelength acts to prevent most photons, emitted by the toner patch sensor, from interacting with toner particles that are present in a lower portion of the toner monolayer. This results in a degraded ability to determine and regulate thickness of the toner layer. Alternatively, use of organic black pigments having low infrared (IR) absorbance, such as perylene black, in a conventional black toner is not cost-effective, and additionally, generates images with a dark greenish hue. Similarly, a conventional black toner that includes a blend of organic color pigments requires large quantities of the organic color pigments to be employed therein for adequate tinctorial strength. Further, use of high levels of total pigment loading for such black toners make it more difficult to fuse and fix the toner particles on a image receiving medium, resulting in images of a poor quality unless a larger and more costly fuser is employed in printer design.

Accordingly, there is a need for a black toner formulation that is capable of exhibiting a low absorbance in the near infrared spectrum. Further, the black toner formulation should be capable of generating images with a dark black hue.

### SUMMARY OF THE DISCLOSURE

In view of the foregoing disadvantages inherent in the prior art, the general purpose of the present invention is to provide a black toner formulation for use in electrophotography, to include the advantages of the prior art while overcoming the inherent drawbacks.

In one aspect, a black toner formulation for electrophotography is described that exhibits a bulk toner powder reflectivity of greater than about 8 percent and less than about 60 percent, at a wavelength of about 940 nanometers, for toner particles having sizes ranging from about 5.5 to about 10 microns. A black toner formulation includes at least one black colorant at a concentration of less than or equal to about 20 percent by weight of the black toner formulation. The at least one black colorant is capable of exhibiting a low absorption in near infrared spectrum ranging from a wavelength of about 700 nanometers to a wavelength of about 1100 nanometers. Further, a black toner formulation includes either a polymeric dispersant, a binder, a wax, or combinations thereof.

### BRIEF DESCRIPTION OF THE DRAWINGS

The above-mentioned and other features and advantages of this disclosure, and the manner of attaining them, will become more apparent and the disclosure will be better understood by reference to the following description of embodiments of the disclosure taken in conjunction with the accompanying drawings, wherein:

FIG. 1 is a plot depiction of an absorbance spectrum for Solvent Black 5 having a concentration of about 21.3 milligram per liter (mg/L);

FIG. 2 is a plot depiction of an absorbance spectrum for Solvent Black 3 having a concentration of about 9.9 mg/L; and

FIG. 3 is a plot depiction of percent reflectance versus wavelength of light for three black toner formulations.

### DETAILED DESCRIPTION

It is understood that various omissions and substitutions of equivalents are contemplated as circumstances may suggest or render expedient, but these are intended to cover the application or implementation without departing from the spirit or scope of the claims of the present disclosure. It is to be understood that the present disclosure is not limited in its application to the details of components set forth in the following description. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the terms “a” and “an” herein do not denote a limitation of quantity, but rather denote the presence of at least one of the referenced item.

As used herein, the term “loading” refers to a concentration of a black colorant, such as carbon black, or a non-black colorant that may be employed in a black toner formulation. The concentration may be represented as “percent” or “percent by weight”. However, it should be apparent that the term may refer to a concentration of a specific component of the black toner formulation with respect to the total concentration of the black toner formulation.

As used herein, the term “tinctorial strength” may refer to an optical absorbance per unit concentration or loading of a colorant.

As used herein, the term “CIE L* a* b*” refers to color space, “CIELAB”, with coordinates L*, a*, and b*. CIELAB is the most complete color model for colors that are visible. The color model was recommended by International Commission on Illumination or Commission Internationale d'Eclairage (CIE) in 1976, as defined in JIS Z 8729 in the Japanese Industrial Standards (JIS). Coordinate L* represents a lightness index of a black toner formulation such that values of L* near zero indicate dark black and values of L* near 100 indicate white. Coordinate a* represents a position between red-to-magenta and green hue for a given color such that negative values of a* indicate green and positive values of a* indicate red. Coordinate b* represents a position between yellow and blue hue for a given color such that negative values of b* indicate blue and positive values of b* indicate yellow.

As used herein, the term “hue” refers to an attribute of a color, in addition to lightness and chroma. More specifically, hue refers to pure spectrum colors or predominant colors that are commonly referred to by “color names” such as red, orange, yellow, blue, and green violet. Further, the term may represent dominant wavelength of any color.

As used herein, the term “chroma” refers to “chrominance” that represents an attribute of a color. More specifically, the term refers to colorfulness of the black toner formulation. Further, the term may be represented by “C*”.

As used herein, the term “halftone” refers to images that include a series of dots in a specific pattern. More specifically, the dots are formed by groups of toner particles that are laid down on a surface during an electrophotographic process. The halftone images produce shades or gradations of color as obtained by a relative darkness and density of the dots. The halftone images may simulate appearances of continuous tone images. The continuous tone images may be represented by various colors and each color is reproduced as a single tone therein.

As used herein, the terms “solids” and “solid areas” refer to continuous tone images that may be converted into black-and-white images. More specifically, the solids or solid areas are represented by the black regions of the black-and-white images.

As used herein, the term “CMY” refers to three-color components of CMYK color model. The three color components as designated by CMY are cyan, magenta, and yellow. The color component K of the CMYK color model represents black.

A black toner formulation is provided herein for use in electrophotography. A black toner formulation includes at least one black colorant, hereinafter referred to as a “black colorant,” for providing a black color to images generated using the black toner formulation. The black colorant may be in the form of a dye, a pigment, or a combination thereof. However, it should be understood that a combination of dyes or a combination of pigments may also be used as the black colorant.

The black colorant is employed at a concentration of less than or equal to about 20 percent by weight of a black toner formulation. Suitable types of the black colorant that may be employed in the black toner formulations include a solvent black colorant, a disperse black colorant, a sulfur black colorant, an indigo colorant, a vat colorant, and modified structures thereof. Suitable examples of solvent black colorants include, but are not limited to, Solvent Black 5, Solvent Black 3, Solvent Black 7, Solvent Black 27, Solvent Black 29, and Solvent Black 34. Suitable examples of sulfur black colorants include, but are not limited to, Sulfur Black 1 and Sulfur Black 6. It should be understood that the black colorant may be a solvent soluble black colorant, an oil soluble black colorant, or a wax soluble black colorant. The black colorant may be milled to produce pigment particles for preparing black toner formulations using an emulsion aggregation process. Alternatively, the black colorant may be dissolved in a mixture of a solvent and a binder that may be a polymeric resin to produce an emulsion of tinted resin particles to be used for preparing black toner formulations of the present invention. In another form, the black colorant may be dissolved in a mixture of a solvent and a binder that may be wax particles to produce an emulsion of tinted wax particles to be used for preparing black toner formulations of the present invention.

The black colorant to be employed is capable of exhibiting a low absorption in near infrared spectrum ranging from a wavelength of about 700 nanometers (nm) to a wavelength of about 1100 nm, and more specifically from about 750 nm to about 1000 nm.

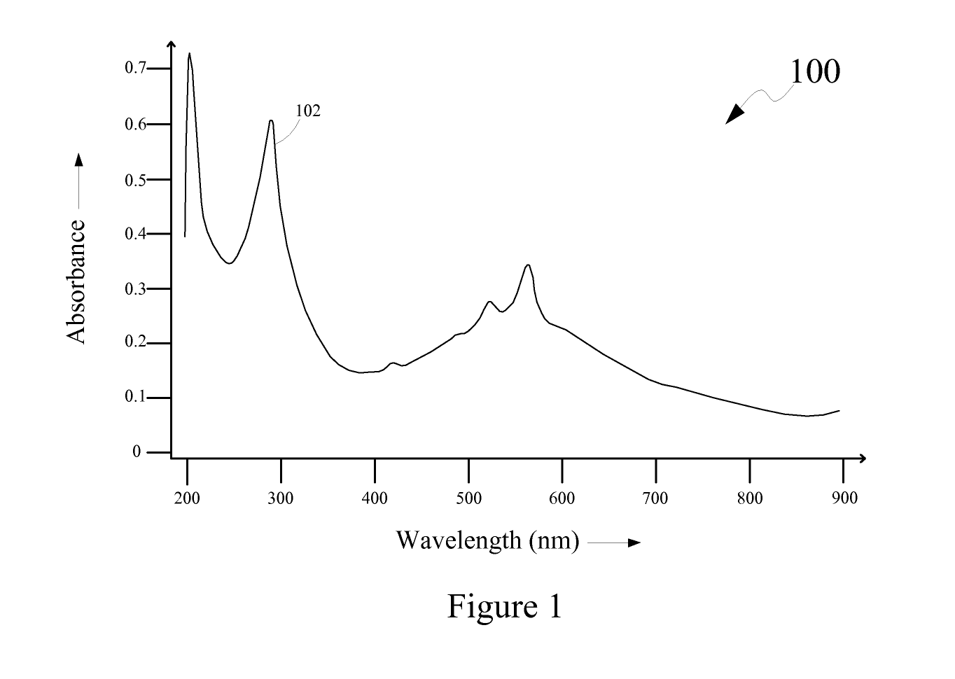

An absorbance spectrum of the black colorant employed in a black toner formulation of the present disclosure may provide a qualitative analysis of absorption characteristics of the black colorant at different wavelengths of light. Such an analysis of absorption characteristics for an exemplary black colorant is explained in conjunction with FIG. 1.

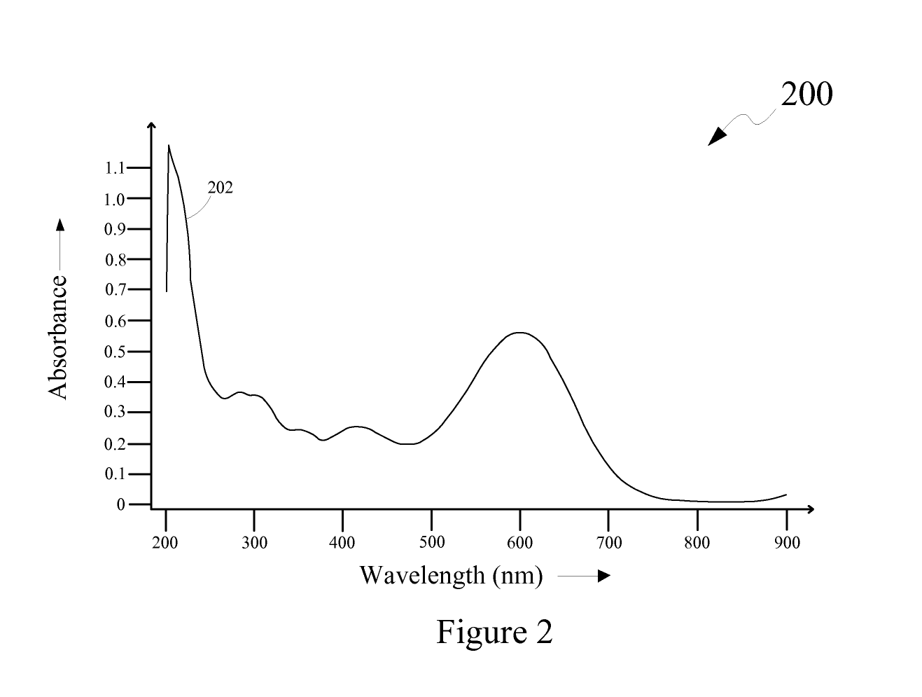

FIG. 1 is a plot depiction of an absorbance spectrum for Solvent Black 5 having a concentration of about 21.3 milligram per liter (mg/L). More specifically, the Solvent Black 5 as used herein is nigrosin. The plot may hereinafter be referred to as “plot 100”. Plot 100 represents the absorbance spectrum, hereinafter referred to as “absorbance spectrum 102” that is characterized by a change in absorbance of the Solvent Black 5 with a change in wavelength of light. Further, an analysis of absorption spectrum 102 shows that the Solvent Black 5 is characteristic of exhibiting a low absorbance at a wavelength of about 900 nm. Therefore, it should be apparent that the Solvent Black 5 may exhibit a weak to moderate absorbance at a wavelength of about 940 nm at which a Toner Patch Sensor (TPS) is capable of emitting and detecting light while monitoring density of a monolayer thereof. Such a property enables the Solvent Black 5 to impart a moderate to low infrared absorptivity or a good infrared reflectivity to the black toner formulation. It should be understood that any other exemplary black colorant is also characteristic of imparting an improved infrared reflectivity to the black toner formulation. Based on the foregoing, an analysis of absorption characteristics for another exemplary black colorant is explained in conjunction with FIG. 2.

FIG. 2 is a plot depiction of an absorbance spectrum for Solvent Black 3 having a concentration of about 9.9 mg/L. More specifically, the Solvent Black 3 as used herein is Sudan Black B. Sudan Black B is soluble in ethanol, acetone, hydrocarbon solvents, fats, oils, and paraffin. An exemplary Solvent Black 3, such as Sudan Black B, may be represented by the following structure:

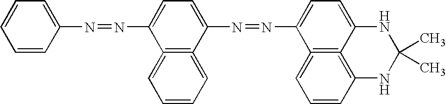

The plot of FIG. 2 may hereinafter be referred to as “plot 200”. Plot 200 represents the absorbance spectrum, hereinafter referred to as “absorption spectrum 202” that is characterized by a change in absorbance of the Solvent Black 3 with a change in wavelength of light. An analysis of plot 200 shows that the Solvent Black 3 is characteristic of exhibiting a low absorbance at a wavelength of about 900 nm.

A comparative analysis of absorbance spectrum 102 of FIG. 1 and absorbance spectrum 202 of FIG. 2 shows that the Solvent Black 3 has a lower absorbance than the Solvent Black 5 at the wavelength of about 900 nm. Such a property enables the Solvent Black 3 to impart relatively higher infrared reflectivity to the black toner formulations. Further, it should be noted that absorbance spectrum 202 of FIG. 2 is depicted for a concentration of the Solvent Black 3 that is about one-half of the concentration of the Solvent Black 5 used for depiction of absorbance spectrum 102 of FIG. 1. Therefore, it should be understood that the Solvent Black 3 has about twice the tinctorial strength of the Solvent Black 5. The foregoing black colorants may be employed either independently or in a combination for preparing the black toner formulations described herein.

A black toner formulation described herein further includes either a polymeric dispersant, a binder, a wax, or combinations thereof.

The polymeric dispersant used in the black toner formulations is capable of dispersing or dissolving the black colorant to prepare the black toner formulation. This combination of the polymeric dispersant and the black colorant may be referred to as a polymeric dispersion. In general, the polymeric dispersant provides strong interaction ability with surfaces of particles of the black colorant. More specifically, the polymeric dispersant helps in controlling size and toner properties of the particles of the black colorant.

The black colorant may be provided with the polymeric dispersant in an appropriate ratio to form a stable black toner formulation. The ratio of the black colorant to the polymeric dispersant may vary from about 1:1 to about 8:1. In one embodiment of the present invention, the ratio of the black colorant to the polymeric dispersant is about 3.5:1.

The polymeric dispersant may include three functional components, namely a hydrophilic component, a hydrophobic component, and a protective colloid component. Without departing from the scope of the present invention, it should be understood that the three functional components may be used in a combination with various other components to prepare the polymeric dispersant for use in the preparation of the black toner formulations of the present invention. In an alternate exemplar, the polymeric dispersant may include a hydrophilic component and a protective colloid component.

The hydrophilic component of the polymeric dispersant may be an ionic monomer such as acrylic acid, methacrylic acid, crotonic acid, or other carboxylic acid containing monomers. The hydrophilic component provides a polymeric backbone for the polymeric dispersant. The hydrophilic component helps in stabilizing the black colorant in an aqueous medium at a pH above about 7. However, it should be understood that a sufficient amount of the hydrophilic component may be employed for a proper dispersion of the black colorant.

The hydrophobic component helps in anchoring the polymeric dispersant to the particles of the black colorant. Therefore, the hydrophobic component may include a polymer or a copolymer including electron rich functional groups such as aromatic groups.

The protective colloid component of the polymeric dispersant provides extra stability thereto in aqueous systems. The protective colloid component helps to buffer the polymeric dispersion during an agglomeration process, thereby effectively controlling particle size growth and size distribution of the black colorant particles. Suitable examples of the protective colloid component include hydroxyethylcellulose acrylate, hydroxyethylcellulose methacrylate, methoxypoly (ethyleneoxy) acrylate, methoxypoly (ethyleneoxy)methacrylate, methylcellulose acrylate, methylcellulose methacrylate, methylcellulose crotonate, stearyloxypoly (ethyleneoxy) acrylate, and combinations thereof.

A commercially available monomer for use in the hydrophobic component and the protective colloid component includes poly (ethylene glycol) 2,4,6-tris-(1-phenylethyl)phenyl ether methacrylate available from Rhodia, USA of Cranbury, N.J. under the trade name SIPOMER SEM 25. Other examples include polydimethylsiloxane methacrylate from Gelest, Inc., polypropylene glycol nonylphenylether acrylate from Toagosei Co. under the trade name ARONIX M-117, and polydimethylsiloxane-co-polypropylene glycol methacrylate.

Reactive surfactants may be employed in the polymeric dispersant as an alternative to using protective colloid component. Examples of the reactive surfactants include, but are not limited to, nonylphenoxy poly (ethyleneoxy) acrylate, nonylphenoxy poly (ethyleneoxy)methacrylate, nonylphenoxy poly (ethyleneoxy) crotonate, bis-nonylphenoxy poly(ethyleneoxy) fumarate, phenoxypoly (ethyleneoxy) acrylate, perfluoroheptoxypoly (propyloxy) acrylate, perfluoroheptoxypoly (propyloxy)methacrylate, sorbitol acrylate, sorbitol methacrylate, and allyl methoxy triethylene glycol ether.

The binder employed in the black toner formulations imparts fusing properties thereto. More specifically, the binder is a polymeric resin. Further, a thermoplastic-type polymer may be used to prepare a suitable binder for use in the black toner formulations. Suitable examples of a polymer for use in the polymeric resin may include, but are not limited to, a polyester polymer, a styrene-acrylate polymer, an acrylic polymer, an epoxy polymer, a urethane polymer, a cyclic olefin copolymer, and combinations thereof. A polystyrene-acrylate emulsion may also be used as the polymeric resin for preparing the black toner formulations of the present invention.

The black toner formulations may further include carbon black at a concentration ranging from about 0.25 to about 2 percent by weight of the black toner formulation. Use of such a small concentration of carbon black that exhibits a reddish hue helps in imparting an intense black color to the black toner formulation. Further, the presence of carbon black that is capable of absorbing light in the near infrared spectrum to some extent enables the black toner formulation to remain responsive to a toner patch sensor.

The black toner formulations may further include one or more non-black colorants to provide either a neutral hue or a black hue to the black toner formulation. The non-black colorant is present in a low concentration. Further, the non-black colorant may be a dye, a pigment, or a combination thereof. In one embodiment, the black toner formulation includes the non-black colorant at a concentration of less than or equal to about 8 percent by weight of the black toner formulation.

Suitable non-black colorants include, but are not limited to, a blue colorant, a cyan colorant, a green colorant, an orange colorant, a brown colorant, a red colorant, a magenta colorant, a violet colorant, and combinations thereof. More specifically, organic colorants or color pigments may be used as the non-black colorant in the black toner formulation. Pigment Yellow 74 and Pigment Orange 71 are suitable examples of the non-black colorant that may be employed in the black toner formulations.

Additionally, the black toner formulations may include a wax as a fusing release agent. The wax used herein has a melting point ranging from a temperature of about 50° C. to about 100° C. Use of the wax helps in improving fixing ability of the black toner formulations when used in an image fixing apparatus for printing purposes. When employed with a binder for use in the black toner formulations, the wax may be uniformly distributed in the binder for improving compatibility of the black toner formulations. Suitable examples of the wax include, but are not limited to, olefin wax such as polyethylene, polypropylene, copolymer polyethylene, grafted polyethylene, and grafted polypropylene; ester-based wax having a long-chain aliphatic group such as behenyl behenate, montanate, and stearyl stearate; plant-based wax such as hydrogenated castor oil and carnauba wax; ketones having a long-chain alkyl group such as distearyl ketone; silicone-based waxes having an alkyl group or a phenyl group; higher fatty acid such as stearic acid; higher fatty acid amides such as oleic acid amide and stearic acid amide; long-chain fatty acid alcohols; long-chain fatty acid polyhydroxy alcohols such as pentaerythritol and partial esters thereof; paraffin-based wax; and Fischer-Tropsch wax.

In addition to the foregoing components, the black toner formulations may include one or more additives. Suitable additives include, but are not limited to, charge control agents, surfactants similar to the reactive surfactants of the polymeric dispersant, emulsifiers, UV absorbers, and combinations thereof.

The charge control agents help in preventing deterioration of charge properties of the black toner formulations. The charge control agents used herein may include the charge control agents that are known in the art.

An exemplary black toner formulation that includes the black colorant, the non-black colorant, and carbon black may gradually fade upon subsequent exposures to ultraviolet radiations. Therefore, to increase UV light fade resistance, UV absorbers may be included in the black toner formulations. Suitable examples of the UV absorbers include, but are not limited to, benzophenone series UV absorbers, benzotriazole series UV absorbers, acetanilide series UV absorbers, cyanoacrylate series UV absorbers, and triazine series UV absorbers.

In one embodiment, an experimental black toner formulation, hereinafter referred to as a “black toner formulation I”, included Solvent Black 5 that was dissolved in a mixture of methylethyl ketone (MEK) and a polyester resin (obtained from Kao Chemicals Inc.). More specifically, the Solvent Black 5 used herein was nigrosin dye powder (obtained from Aldrich Chemicals). The foregoing components formed an emulsion of black latex particles to be used for producing the black toner formulation I with a 5 percent loading of nigrosin.

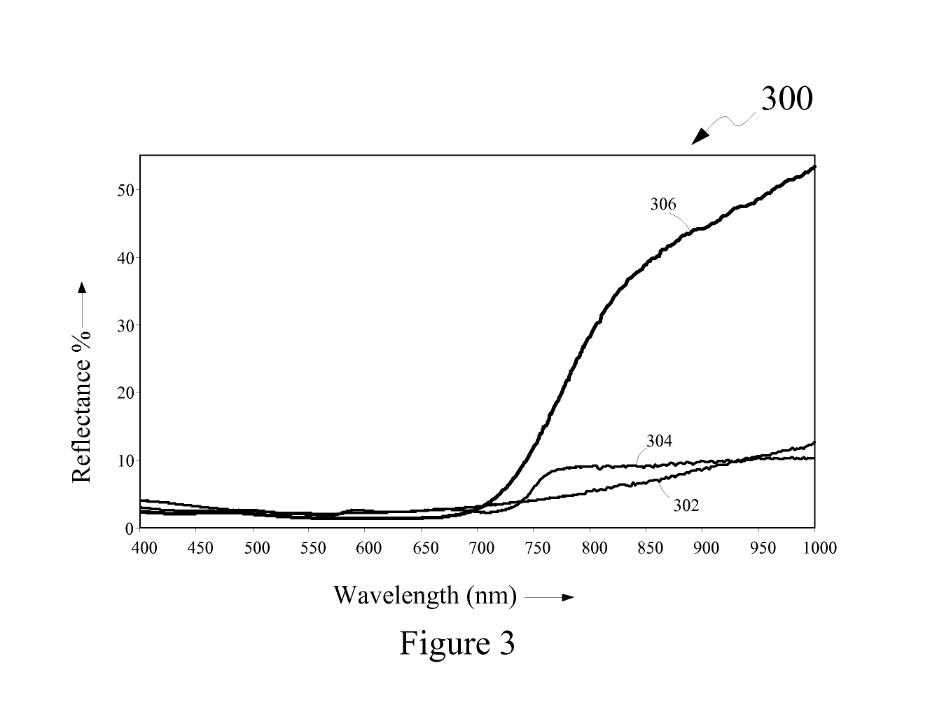

FIG. 3 is a plot depiction of percent reflectance versus wavelength of light for three black toner formulations. The plot may hereinafter be referred to as “plot 300. More specifically, plot 300 represents reflectance spectra representing bulk powder diffuse reflectance for the three black toner formulations. The three black toner formulations, as used herein, are the black toner formulation I; a second exemplary toner formulation that includes 1.5 percent of NiPex 90 carbon black (obtained from DeGussa) and three organic color pigments; and a third exemplary toner formulation that includes Solvent Black 3. The black toner formulations made with Solvent Black 3 and Solvent Black 5 did not incorporate any additional colorant and exhibited unacceptable hue characteristics. Further, the two black toner formulations were made to assess effect of the Solvent Black 3 and Solvent Black 5 dyes on the IR absorbance and any possible impact on toner charging characteristics.

Plot 300 represents a reflectance spectrum 302 for the black toner formulation I, a reflectance spectrum 304 for the second exemplary toner formulation, and a reflectance spectrum 306 for the third exemplary toner formulation. As observed, in near infrared spectrum, at about 940 nm, powder reflectance values for the black toner formulation I and the second exemplary toner formulation are very similar, measuring approximately about 10 percent. However, the powder reflectance value for the third exemplary toner formulation, at wavelengths near 940 nm, is approximately about 47 percent. The powder reflectance hereinafter may interchangeably be referred to as “toner powder reflectivity”. The optimum toner powder reflectivity for toners with particles having a diameter of about 6 microns is in a range of about 15 to about 20 percent. Black toner formulations with toner powder reflectivities, at a wavelength near 940 nm, in the aforementioned range will have an optimum combination of light absorption and transparency characteristics for controlling solid area darkness using a toner patch sensor algorithm disclosed in U.S. patent application Ser. No. 11/771,121, filed on Jun. 29, 2007, the subject matter of which is incorporated by reference herein.

From FIG. 3, it should be understood that black toners may be formulated using Solvent Black 3 in combination with other colorants to have a powder reflectivity in the optimum range at any wavelength near 940 nm. For example, black toner formulations using Solvent black 3 in combination with carbon black and other color pigments may be used to produce black toners with toner powder reflectivities in the above-specified optimum range for toner patch sensing. Further, such black toners are characteristic of displaying neutral hues.

Based on the above-mentioned toner powder reflectance values, it should be understood that the present invention provides different black toner formulations, such as the black toner formulation I and the third exemplary toner formulation, that exhibit a low absorption in the near infrared spectrum and exhibit a bulk toner powder reflectivity of greater than about 8 percent and less than about 60 percent, at a wavelength of about 940 nm, for toner particles having sizes ranging from about 5.5 to about 10 microns.

It is also possible to make black toner formulations without carbon black such that the black toner formulations still have bulk toner powder reflectivities in the above-specified optimum range at any wavelength from about 800 nm to about 1000 nm. This may be accomplished by using a mixture of solvent black 3 and solvent black 5 in order to achieve the desired toner powder reflectance value with one or more additional colorants added to achieve an acceptable and neutral hue. One may also contemplate that black toner formulations may employ combinations of one or more solvent black dyes, carbon black, and other non-black colorants to achieve the desired toner powder reflectance and the desired neutral hue.

In another embodiment, a black toner formulation was prepared using nigrosin pigment milled down in particle size from the nigrosin powder. The black toner formulation exhibited bulk toner powder reflectivity and darkness similar to the bulk toner powder reflectivity and darkness of the black toner formulation I. This showed that there is no significant difference between the tinctorial strength of a black toner formulation that includes nigrosin chemically dispersed in a solvent and the tinctorial strength of a black toner formulation that includes milled form of nigrosin when used as a pigment.

Various conventional methods may be employed to prepare different types of the black toner formulation of the present disclosure. It should be understood that conventional methods may be used for preparing various types of black toner formulations of described herein, including the black toner formulation I.

As an illustrative example, a method for preparing one of the black toner formulations includes melt mixing a resin with a black colorant, and other additives, to form a melt-mixed composition. The melt-mixed composition may be crushed, pulverized, milled, and classified to provide fine toner particles of a desired size.

As an alternate illustrative exemplar, the method includes preparation of a “chemically produced toner” (CPT) formulation. More specifically, the method includes a chemical process such as aggregation or polymerization in order to produce toner particles that may be employed for preparing the black toner formulation.

One of ordinary skill in the art, and based on a reading of this detailed description, would recognize that, the specific examples described hereinafter are intended to illustrate, not limit, the scope of the present disclosure.

### EXAMPLE 1

In the following example, a method for preparing a black toner formulation employing nigrosin and a polymeric dispersant is explained. The polymeric dispersant was prepared in a solution form. More specifically, the solution was prepared using about 80.0 grams of SIPOMER SEM 25, about 12.6 grams of ARONIX M-117 (polymerizable monofunctional vinyl monomers available from Toagosei Co. of Tokyo, Japan), about 6.4 grams of 1-dodecanethiol, about 23.6 grams of methacrylic acid, and about 0.3 grams of dimethyl 2,2′-azobisisobutyrate (V-601, obtained from Waco Chemical & Supply Co. of Dalton, Ga.) in about 75 grams of isopropyl alcohol. The SIPOMER SEM 25, used herein, includes about 60 percent of an active component, about 20 percent of an acid, and about 20 percent of water. The foregoing chemicals were mixed together in a flask equipped with a mechanical stirrer, a condenser, and a thermometer. Further, the chemicals were degassed with nitrogen. The flask was then backfilled with nitrogen. Subsequently, the flask was immersed in an oil bath, and thereafter heated to a temperature of about 78° C. for about 18 hours. This treatment resulted in the preparation of a product that was then dried in an oven at a temperature of about 80° C. The molecular weight of the product was determined using Gel Permeation Chromatography (GPC) technique. The product so-obtained exhibited an average weight molecular weight of about 7200 and a number average molecular weight of about 5000. Further, the product was then dissolved in deionized water. The pH of the solution was adjusted to about 7.8 by a dropwise addition of about 20 percent potassium hydroxide (KOH).

In order to disperse a black colorant such as nigrosin in the above prepared polymeric dispersant, about 50 grams of nigrosin powder was mixed with about 178 grams (about 8 percent) of the above-prepared polymeric dispersant and about 10 grams of deionized water. The mixture was ground using an Eiger Mill (obtained from Eiger Machinery Inc.) for about 2 hours with nigrosin to the polymeric dispersant ratio of about 3.5:1 and about 12.65 percent of solid material (9.84 percent nigrosin). Grinding and milling the mixture led to production of nigrosin particles with an average size of about 228 nm. The particle size was measured using Nanotrac 150 (obtained from Microtrac Inc.). Such a dispersion of nigrosin with polymeric dispersant may hereinafter be referred to as nigrosin dispersant.

The nigrosin dispersant may then be used to prepare a black toner formulation that includes 5 percent loading of nigrosin and a styrene-acrylate resin. The black toner formulation may be referred to as a styrene-acrylate-based black toner formulation.

It should be understood that the method disclosed herein may also be employed for dispersing the black colorant for preparing a CPT. More specifically, the black colorant may be a pigment colorant.

Further, a wax emulsion may be employed to prepare the black toner formulations. Accordingly, the method for preparing the wax emulsion, for use with any specific black colorant of the present disclosure, may include measuring about 26 grams of a solid form of the polymeric dispersant. To the measured amount of the polymeric dispersant, water may be added to form a solution. Further, water may be added at an optimum amount such that a total amount of water in the solution reaches a value of about 900 grams. It should be understood that the total amount of water includes the amount of water that is present in the polymeric dispersant. The method further may include heating the solution so-obtained at a temperature of about 90° C. The heated solution may then be dispersed using a high shear mixer at a speed of about 4,000 rotations per minute. Subsequently, the speed may be increased to about 10,000 rotations per minute. To the mixer holding the dispersed solution, about 26 grams of wax may be added and the temperature may be maintained within a range of about 85° C. to about 95° C. for about 15 minutes, while keeping the mixer at the speed of 10,000 rotations per minute. More specifically, the temperature is preferably maintained at about 90° C. The wax used herein may have a melting point of about 85° C. The foregoing method helps in preparing a wax emulsion that may then be subjected to a treatment in a microfluidizer for about 15 minutes or until particles present in the wax emulsion achieve a particle size of about 200 nm.

However, it should be apparent to a person skilled in the art that the method may employ different concentrations and ratios of wax emulsions depending upon the requirement.

Alternatively, a black toner formulation may be prepared using a general CPT emulsion aggregation method. The method includes mixing about 5 percent of nigrosin, about 6 percent of the wax, about 3.7 percent of a charge control agent, and about 83 percent of a styrene-acrylic polymer resin. The method further includes an aggregation of the above mixture to produce toner particles with an average particle size of about 5.7 micrometer (μm) with about 7.7 percent of the toner particles smaller than about 3 μm, and an average circularity of about 0.97. The particle size may be analyzed by Sysmex FPIA-2100, a particle shape analyzer tool.

### EXAMPLE 2

The method as disclosed in example 1 may be used for preparing a black toner formulation that includes about 5 percent of nigrosin, about 1 percent of Nipex 35, about 0.755 percent of Pigment Yellow 74, and about 6 percent of wax. The method used for preparing the black toner formulation using the foregoing components helped in producing toner particles with an average particle size of about 7.1 μm with about 1.73 percent of the toner particles smaller than about 3 μm, and an average circularity of about 0.972.

### EXAMPLE 3

In the following example, a method for preparing a black toner formulation employing a polymeric resin is explained. The method included dissolving about 5 grams of nigrosin in about 135 grams of MEK that required an overnight mixing of the foregoing components. Subsequently, about 45 grams of a polyester resin (obtained from Kao Chemicals Inc.) was added to the mixture to form a solution thereof. Further, the method included addition of about 2.5 grams of 10 percent of NH₄OH in 150 grams of deionized water, to the solution. While emulsifying, the solution was subjected to a high-speed agitation. Further, pH of the solution was maintained at about 7 to 7.5. The MEK was then removed using a rotary evaporator to yield a final aqueous emulsion.

The method further included mixing the final aqueous emulsion with about 45 grams of polystyrene-acrylate emulsion, about 6 grams of wax, and about 3.7 grams of a charge control agent. The mixture of the foregoing components was agglomerated with about 200 grams of 1 percent sulfuric acid. Subsequently, the agglomerated mixture was heated to form toner particles. While heating, particle size of the toner particles was monitored and controlled by adding about 6 percent sodium hydroxide (NaOH). After controlling the particle size of the toner particles to about 6 μm, heating was stopped. However, temperature at which the toner particles attain the particle size of about 6 μm was then maintained for about 2 to 3 hours. Subsequently, heating was then resumed to a temperature of about 70° C. The so-obtained toner particles were transferred to a parr reactor and were heated at a temperature of about 100° C. for about 5 minutes to form final particles having an average size of about 7.1 μm, and about 7.6 percent of the final particles smaller in size than about 3 μm. Further, the final particles exhibited a circularity of about 0.915 as analyzed by Sysmex FPIA-2100 analyzer.

The black toner formulation of example 3 may hereinafter be referred to as a mixed resin-based black toner formulation.

### EXAMPLE 4

In the following example, an alternate method for preparing a black toner formulation employing a polymeric resin is explained. The method included mixing and heating about 5 grams of nigrosin, about 2.5 grams of Sandoplast Black FHB (obtained from Clariant), and about 450 grams of MEK at a temperature of about 60° C. The mixing and heating was accompanied by a constant overnight stirring of a mixture of the foregoing components to form a solution. To the solution, about 150 grams of polyester resin (obtained from Kao Chemicals Inc.) was added and stirring was continued until the polyester resin was completely dissolved. The solution containing the polyester resin was emulsified with about 8.5 grams of 10 percent NH₄OH in about 500 grams of deionized water. Subsequently, the MEK was evaporated using a rotary evaporator to form an emulsion.

The emulsion so-obtained was then used to make the black toner formulation with about 5 percent of nigrosin using the method as explained in example 3. However, the black toner formulation of example 4 may be prepared in the absence of polystyrene-acrylic emulsion used in example 3. Analysis of the final particles so-obtained exhibited a particle size of about 6.0 μm with a circularity of about 0.98, and about 2 percent of the final particles smaller in size than about 3 μm.

As understood from the above descriptions, in addition to the styrene acrylate-based black toner formulation of example 1 and the mixed resin-based black toner formulation of example 3, a polyester-based black toner formulation may be prepared using an emulsion aggregation process. Alternatively, a milled polyester-based black toner formulation may be prepared by dispersing pigments of the black colorant into a polyester resin as described in the above-disclosed examples. Therefore, the black colorant in a form of a colored thermoplastic-type resin may serve as a “pigment masterbatch” that may be mixed in an extruder with the unpigmented polyester resin to prepare the polyester-based black toner formulation.

Described herein are black toner formulations that includes at least one black colorant. Further, the black toner formulations includes either a polymeric dispersant, a binder, a wax, or combinations thereof. The ability of the black colorant to exhibit sufficiently low absorption in near infrared spectrum helps in reliably generating intense dark images. Further, this property of the black colorant enables the black toner formulations to exhibit moderate to low absorbance in the near infrared spectrum. Therefore, the black toner formulations serve as an effective toner formulations for use in electrophotography. Further, the black toner formulations may include optimum concentrations of one or more non-black colorants to provide a near black hue thereto. In addition, it should be obvious to persons skilled in the art that the efficiency of the black toner formulation of the present disclosure depends on the composition thereof, concentrations of various components thereof, and chemistry or compatibility among the various components. Without departing from the scope, the present invention also relates to solvent dispersion of the black (and any non-black) colorant to produce tinted resin particles. The tinted resin particles, also referred to as tinted resin pellets, then may be extruded for mixing in carbon black and/or other pigments to produce milled toners. Such milled toners may exhibit good darkness, good hue, and good infrared reflectance. Therefore, the aforementioned technique eliminates use of high loadings of non-black pigments for extruding of the toners, thereby avoiding any difficulty to achieve adequate dispersion of pigment particles. Alternatively, use of low concentrations of pigment particles in the black toner formulations described herein enables toner particles to fuse easily.

The foregoing description of several embodiments has been presented for purposes of illustration. It is not intended to be exhaustive or to limit the present invention to the precise forms disclosed, and obviously many modifications and variations are possible in light of the above teaching. It is intended that the scope of the invention in the black toner formulations be defined by the claims appended hereto.

What is claimed is:

1. A black toner formulation for electrophotography, the black toner formulation comprising:
at least one black colorant at a concentration of less than or equal to about 20 percent by weight of the black toner formulation, the at least one black colorant capable of exhibiting a low absorption in near infrared spectrum ranging from a wavelength of about 700 nanometers to a wavelength of about 1100 nanometers; and
at least one of a polymeric dispersant, a binder, a wax, and combinations thereof,
wherein the black toner formulation exhibits a bulk toner powder reflectivity of greater than about 8 percent and less than about 60 percent, at a wavelength of about 940 nanometers, for toner particles having sizes ranging from about 5.5 to about 10 microns.

2. The black toner formulation of claim 1 wherein the at least one black colorant is selected from the group consisting of a dye, a pigment, and a combination thereof.

3. The black toner formulation of claim 1 wherein the at least one black colorant is selected from the group consisting of a solvent black colorant, a disperse black colorant, a sulfur black colorant, an indigo colorant, a vat colorant, and modified structures thereof.

4. The black toner formulation of claim 1 wherein the binder is a polymeric resin.

5. The black toner formulation of claim 4 wherein the polymeric resin comprises a polymer selected from the group consisting of a polyester polymer, a styrene-acrylate polymer, an acrylic polymer, an epoxy polymer, a urethane polymer, a cyclic olefin copolymer, and combinations thereof.

6. The black toner formulation of claim 1 further comprising carbon black at a concentration of about 0.25 to about 2 percent by weight of the black toner formulation.

7. The black toner formulation of claim 1 further comprising a non-black colorant selected from the group consisting of a blue colorant, a cyan colorant, a green colorant, an orange colorant, a yellow colorant, a brown colorant, a red colorant, a magenta colorant, a violet colorant, and combinations thereof.

8. The black toner formulation of claim 7 wherein the a non-black colorant is up to about 8% by weight of the total toner formulation.

9. The black toner formulation of claim 1 further comprising an additive selected from the group consisting of a charge control agent, a surfactant, an emulsifier, a UV absorber, and combinations thereof.

10. The black toner formulation of claim 9 wherein the UV absorber is one of a benzophenone series UV absorber, a benzotriazole series UV absorber, an acetanilide series UV absorber, a cyanoacrylate series UV absorber, and a triazine series UV absorber.

11. The black toner formulation of claim 1 wherein the wax has a melting point ranging from a temperature of about 50° C. to about 100° C.

12. The black toner formulation of claim 1 wherein the wax is one an olefin wax, a plant-based wax, a ketone having a long-chain alkyl group, a silicone-based wax silicone-based wax having an alkyl group or a phenyl group, a higher fatty acid; a higher fatty acid amide, a long-chain fatty acid alcohol, a long-chain fatty acid polyhydroxy alcohol, a paraffin-based wax; and Fischer-Tropsch wax.

13. The black toner formulation of claim 1 wherein the ratio of black colorant to polymeric dispersant is from about 1:1 to about 8:1.

14. The black toner formulation of claim 13 wherein the ratio of black colorant to polymeric dispersant is from about 3.5:1.

15. The black toner formulation of claim 1 further comprising at least one additive selected from a charge control agent, a surfactant, an emulsifier, a UV absorber, and combinations thereof.

16. The black toner formulation of claim 15 wherein the UV absorber is one of a benzophenone series UV absorber, a benzotriazole series UV absorber, an acetanilide series UV absorber, a cyanoacrylate series UV absorber, and a triazine series UV absorber.

17. The black toner formulation of claim 1 wherein the polymeric dispersant comprises a hydrophilic component, a hydrophobic component and a protective colloid component.

18. The black toner formulation of claim 17 wherein the protective colloid component is one of hydroxyethylcellulose acrylate, hydroxyethylcellulose methacrylate, methoxypoly (ethyleneoxy) acrylate, methoxypoly (ethyleneoxy)methacrylate, methylcellulose acrylate, methylcellulose methacrylate, methylcellulose crotonate, stearyloxypoly (ethyleneoxy) acrylate, and combinations thereof.

19. The black toner formulation of claim 17 wherein the hydrophobic component comprises one of poly (ethylene glycol) 2,4,6-tris-(1-phenylethyl)phenyl ether methacrylate, polydimethylsiloxane methacrylate, polypropylene glycol nonylphenylether acrylate, and polydimethylsiloxane-co-polypropylene glycol methacrylate.

20. The black toner formulation of claim 1 wherein the polymeric dispersant comprises a hydrophilic component, a hydrophobic component and a reactive surfactant.

21. The black toner formulation of claim 20 wherein the reactive surfactant comprises one of nonylphenoxy poly (ethyleneoxy) acrylate, nonylphenoxy poly (ethyleneoxy)methacrylate, nonylphenoxy poly (ethyleneoxy) crotonate, bis-nonylphenoxy poly(ethyleneoxy) fumarate, phenoxypoly (ethyleneoxy) acrylate, perfluoroheptoxypoly (propyloxy) acrylate, perfluoroheptoxypoly (propyloxy)methacrylate, sorbitol acrylate, sorbitol methacrylate, and allyl methoxy triethylene glycol ether.

22. The black toner formulation of claim 1 wherein the black colorant is one of an emulsion of tinted resin particles and an emulsion of tinted wax particles.
